(19) United States
(12) Patent Application Publication
(10) Pub. No.: US 2010/0269974 A1
(43) Pub. Date: Oct. 28, 2010

(54) METHOD FOR MANUFACTURING A FIBROUS CELLULAR STRUCTURE

(75) Inventor: Patrick David, Saint Cyr Sur Loire (FR)

Correspondence Address: Nixon Peabody LLP, P.O. Box 60610, Palo Alto, CA, 94306, US

(73) Assignee: COMMISSARIAT A L'ENERGIE ATOMIQUE ET AUX ENERGIES ALTERNATIVES, Paris (FR)

(21) Appl. No.: 12/743,364

(22) PCT Filed: Nov. 17, 2008
(86) PCT No.: PCT/EP2008/065638

§ 371 Date: May 17, 2010

(30) Foreign Application Priority Data
Nov. 19, 2007 (FR) 07 59149

(51) Int. Cl. B32B 37/02; B32B 37/24

(52) U.S. Cl. 156/71

(57) ABSTRACT

The invention relates to a method for manufacturing a cell structure (for example a honeycomb structure) comprising cells separated by walls, the method including the following steps: manufacturing of a retaining device comprising rods reproducing the shape of the cells, the rods being separated by grooves reproducing the shape of the walls; placement of continuous fibres in the grooves to form the walls, each fibre being placed in several successive adjacent grooves; and formation of a matrix around fibres so as to bind the fibres to each other.

### CROSS REFERENCE TO RELATED APPLICATIONS OR PRIORITY CLAIM

This application is a national phase of International Application No. PCT/EP2008/065638, entitled, “Method For Producing A Cellular Fibrous Structure”, which was filed on Nov. 17, 2008, and which claims priority of French Patent Application No. 07 59149, filed Nov. 19, 2007.

### DESCRIPTION

1. Technical Field

The invention relates to a method for manufacturing a fibrous cellular structure, particularly a honeycomb fibrous structure comprising cells with walls composed of continuous fibres.

2. State of Prior Art

A honeycomb structure (also called a NIDA structure) is a cellular structure composed of hollow cylinders adjacent to each other and arranged according to a pattern. In general, cylinders have a hexagonal base and are arranged in a hexagonal pattern, but other basic forms and other patterns are also possible. This honeycomb arrangement confers high mechanical properties to the structure, particularly high mechanical strength, while remaining lightweight.

Composite NIDA structures are defined from their component elements, in other words fibres and their matrix. Fibres provide mechanical properties to the NIDA structure. The matrix is the material present between the fibres and its function is to bind the fibres to each other; the matrix confers cohesion to the structure.

Composite NIDA structures are classified as a function of their matrices (organic, ceramic or metallic).

Two conventional techniques are used to make NIDA structures with an organic matrix (see document [1] referenced at the end of the description):

the expansion technique;

the corrugated boards forming technique.

The first technique (expansion technique) consists of using a woven material comprising fibres (for example a fabric of pre-impregnated resin fibres), cutting it in the form of sheets with equal dimensions and depositing parallel lines of resin or glue on these sheets. The material used for the sheets is the material that will form the walls of the cells in the NIDA structure.

The width of resin or glue lines is equal to the width of a wall of a cell in the future NIDA structure, while the spacing between two adjacent lines is equal to three times the width of a wall. For each new sheet, the glued zones are offset by a distance of two wall widths from the previous sheet.

These sheets are then stacked on each other and a heat treatment is applied to the stack, possibly under pressure, which polymerises the resin or the glue and creates bonds between the sheets. Thus, each sheet is in contact with the sheet above it and with the sheet below it over a quarter of its surface.

The resulting stack is then cut into strips with a given width and each strip is then stacked in the direction of the stack thickness until hexagonal cells are obtained. A heat treatment polymerises the resin and results in a rigid material.

The second technique (corrugated board forming technique) can be applied to various materials that are in the form of sheets and that are deformable (metal, plastic, fabric).

Sheets made of a deformable material are shaped either by stamping at high temperature and passing between rolls with surface corrugation relief (for metal or plastic sheets) or by placement in moulds with a corrugated profile and injection of resin (for sheets in form of fabric).

The corrugated boards thus obtained are then glued to each other at their projecting parts in order to form cells.

Use of the two techniques mentioned above is fairly simple and inexpensive. However, these two techniques have the following disadvantages:

the wall thicknesses of the resulting NIDA structures are not constant because one wall out of three is twice as thick as the previous and the next wall (corresponding to the contact zone between two adjacent corrugated sheets or boards);

there are no fibres binding one sheet to the next, which makes the structure less strong. In particular, there are risks of separation (opening) at the edges of the cells corresponding to the junction of two adjacent sheets;

the precision on cell dimensions cannot be greater than 3/10^{th} mm, due to gluing and shaping operations of the sheets;

it is impossible (for a third of the walls) to obtain a wall thickness less than two sheet thicknesses which gives a thickness of about 600 μm with sheets made of conventional fabrics.

Secondly, it may be advantageous to make NIDA structures with a ceramic or carbon matrix, because they can be used at high temperature and they can be stiffer than NIDA structures with an organic matrix.

Composite NIDA structures with a carbon or ceramic matrix can be obtained from a NIDA composite structure with an organic matrix made using one of the methods described above.

For example, document [2] describes the formation of a carbon/carbon NIDA structure obtained by pyrolysis of a NIDA structure comprising carbon fibres and a thermosetting organic matrix (in this case the organic matrix is chosen such that its pyrolysis results in a high carbon content). The problem with this method is that the structural matrix thus obtained is relatively not very dense and comprises cracks. In order to consolidate and densify the structure, it is then necessary to introduce carbon into the structure using the conventional Chemical Vapour Infiltration (CVI) technique. Carbon may possibly be replaced by silicon carbide if the structure has to be used at high temperature under oxidising conditions.

The structures obtained by this technique have the same disadvantages as those specific to NIDA structures with an organic matrix (like those mentioned above), given that the structures are obtained from a NIDA structure with an organic matrix and therefore maintain defects related to the thickness, the precision in dimensions and the absence of junction fibres (between cell walls).

Furthermore, pyrolysis transforms the thermosetting resin into a porous carbon, but the porous carbon obtained comprises few access paths; therefore CVI densification cannot subsequently reach the core of the fibre material (CVI does not penetrate beyond the fibre surface). Consequently, the mechanical properties (and particularly the strength) of NIDA structures obtained using this technique are much lower than the properties of NIDA structures that are fully densified by CVI.

Furthermore this technique cannot provide high performance ceramic NIDA structures, for example such as SiC/SiC structures. In order to produce a high performance SiC/SiC composite, a very thin carbon coat (a few hundred nanometers) has to be deposited on silicon carbide fibres by CVI directly, before densification by silicon carbide. This layer then plays a preponderant role in the performances of the SiC/SiC structure by allowing deviation of cracks and adaptation of bonding forces between fibres and the matrix. However, only carbon deposits obtained by a gaseous method have these properties. When pyrolyzed material is present on the fibre surface, which is the case with the technique considered, it is no longer possible to deposit the required carbon coats.

Another method of obtaining ceramic matrix structures is described in document [3]. This method consists of cutting parallel slits in a felt (or in a needled structure), and then forcing laterally-expandable hexagonal rods to penetrate into these slits. For example, these expandable rods might be elements that can be expanded with a gas.

During expansion of the rods, the felt fibres are displaced and match the contours of the rods to form cells with a hexagonal base.

The felt may be impregnated with resin or a ceramic precursor before the cells are formed. Polymerisation of the resin or the precursor can then consolidate the structure. The NIDA structure thus obtained is then pyrolyzed so as to obtain a carbon or ceramic matrix structure.

The structures obtained using this technique do not have any delamination problems, since fibres pass through all walls of the structure. However, the disadvantages mentioned below arise.

Since the cells are obtained by stretching felt along a direction perpendicular to the slits, the total volume of the structure is multiplied by a factor d/e (where d is the distance between two walls and e is the wall thickness) relative to the initial volume of the felt. Therefore, the density of fibres in the walls is increased on average by a factor of d/e relative to the density of the felt. Therefore, this method makes it necessary to make felt with a given density beforehand, if it is required to control the average fibres content in the walls and particularly to achieve the maximum value of the content while maintaining a precise thickness for the walls in the final NIDA structure. However, manufacturers only market felts with a single density (about 0.1) for ceramic fibres such as SiC fibres. Therefore, with this method it is impossible to choose the thickness of the walls of the structure for a defined fibre content.

Furthermore, a proportion of the fibres is cut when slits are cut, and other fibres are torn during stretching. The fraction of damaged fibres increases as the size of the hexagonal cells increases, and as the wall thickness reduces (the cell size and the wall thickness control the distance between two cut lines). The fraction of damaged fibres is particularly high when fibres are more rigid. This has the result of degrading the mechanical properties of the resulting NIDA structure.

Finally, stretching is not uniform in all directions. Stretching only takes place along three directions that form angles of 0°, +30° or −30° with the axes of the walls in the NIDA structure, which results in different fibre contents along different wall orientations.

Note that NIDA structures can be used to make panels with a cellular structure by gluing one or several boards (for example sheets) of fabric pre-impregnated with resin on the upper face and/or the lower face of the NIDA structures, and polymerising the assembly thus obtained. For example, if a carbon/carbon NIDA structure is used, the faces of this structure can be covered using closing boards composed of several thicknesses of carbon fabric impregnated with resin. The assembly is then pyrolyzed.

The purpose of the invention is to provide a manufacturing method to obtain a cellular structure (for example a honeycomb structure) that does not have the disadvantages of prior art, in other words a structure for which the walls are strong and have a constant and controlled thickness and density.

### PRESENTATION OF THE INVENTION

The purpose of the invention is a method for manufacturing a cellular structure comprising cells separated by walls. The method includes the following steps:

manufacturing of a retaining device comprising rods reproducing the shape of the cells, the rods being separated by grooves reproducing the shape of the walls,

placement of continuous fibres in the grooves to form the walls, each fibre being placed in several successive adjacent grooves,

formation of a matrix around fibres so as to bind the fibres to each other.

Placement of a continuous fibre in the grooves of the retaining device, in other words in volumes equivalent to the walls of the structure to be made, allows to achieve homogeneity of the wall thickness and better mechanical strength of the walls. Indeed, a single fibre belongs to several adjacent walls: therefore the walls are connected to each other by fibres.

Note that formation of the matrix around the fibres provides a means of creating cohesion between the fibres.

Advantageously, the method comprises an additional step to eliminate the retaining device, after the step in which a matrix is formed.

Advantageously, the manufacturing method also includes a step after the step to place continuous fibres in the grooves of the retaining device and before the step to form a matrix around the fibres, in which fibres are compacted in the grooves of the retaining device.

According to one variant, placement is done with at least one single continuous fibre that travels n times from side to side of the retaining device, where n≧1.

Advantageously, placement is done with at least one single continuous fibre that passes through all the grooves of the retaining device.

Advantageously, the fibre placement step comprises the following steps:

take a given groove called groove x (see FIG. 1A), placement of a continuous fibre in the grooves with average orientation 90° relative to groove x,

placement of a continuous fibre in the grooves with average orientation −30° relative to groove x,

placement of a continuous fibre in the grooves with average orientation +30° relative to groove x,

an average orientation of θ° corresponding to an orientation of θ equal to + or −30°.

Several cycles are performed in which fibres are placed in the three directions until the required structure height is achieved.

Other fibre paths, for example along the three sides of each hexagon, may be used.

According to a first variant, each groove in the retaining device comprises a single fibre in its thickness. Therefore, the width of the grooves is adapted so as to only contain a single fibre.

According to a second variant, several fibres are placed in the grooves at the same time instead of a single fibre. The thickness of the set of fibres can thus be adapted to the width of the grooves in the retaining device.

Obviously, several fibres may be placed in the grooves simultaneously, depending on the width of the grooves.

Advantageously, the cells are cylinders with a hexagonal base.

Advantageously, the rods of the retaining device are arranged in a hexagonal pattern. In this case, the expression “hexagonal pattern” refers to the pattern formed by several adjacent rods, for example a group of 7 adjacent rods. The rods are arranged uniformly in a pattern that is different depending on the shape of the bottom of the rods, so that the grooves thus created between the rods can be filled by fibres and form a determined honeycomb structure.

Advantageously, the rods of the retaining device are supported on a support, this support being plane, conical or cylindrical in shape. In fact, the rods of the retaining device are arranged on a plane support when it is required to obtain a plane NIDA structure. On the other hand, when it is required to obtain cylindrical or conical shaped NIDA structures, etc., the rods in the retaining device are arranged on supports with the required shape (cylindrical, conical, etc.). Note that the rods are arranged essentially perpendicular to the support surface, regardless of the shape of the support.

The rods of the retaining device may be made of carbon, metal or any other material compatible with production conditions.

Advantageously, the rods of the retaining device are coated with fabric or braids composed of fibres; this makes it possible to add fibres in a vertical plane, while maintaining the total thickness of the walls and keeping a constant fibre content.

Advantageously, the manufacturing method also comprises the following steps after the step in which the matrix is formed around the fibres:

placement of a fibrous reinforcement on one or two faces of the structure so as to cover the ends of the structure cells,

fixing the fibrous reinforcement on said face(s), for example by insertion of filaments or fibres passing through the fibrous reinforcement and the walls of the cells in the structure.

By placing a fibrous reinforcement on the structure, the ends of the cells can be closed and blocked off. The fibrous reinforcement may be plane, cylindrical or conical in shape, adapted to the surface of the walls of the cellular structure. The fibrous reinforcement may be a plane woven element, a felt or a similar material.

Advantageously, when the retaining device has to be removed during the manufacturing process, the fibrous reinforcement may be placed on one or both faces of the structure after the step in which the retaining device is eliminated. Advantageously, the fibrous reinforcement may also be placed before the step in which the retaining device is eliminated. In this case, elimination may be done by applying a heat treatment on the entire object (cellular structure and retaining device).

According to one particular embodiment, the cellular structure is a honeycomb structure (NIDA). The cells of the NIDA structure are preferably hexagonal in shape.

According to another particular embodiment, the cellular structure is a structure in which the sections of the cells have a triangular or parallelepiped shape (square, rectangle or diamond).

In fact, the cellular structure may be any structure in which the cells can be made by the placement of continuous fibres in grooves reproducing the shape of the walls of the cells (straight lines or intersecting curves with periodic or non-periodic patterns).

Depending on the nature of the fibres and the matrix used, the method according to the invention can be used to obtain a cellular structure (for example a NIDA structure) composed of continuous organic or inorganic (glass), ceramic or carbon fibres and an organic, ceramic or carbon matrix.

According to a first variant, the matrix is obtained by injection of a thermoplastic compound between fibres placed in the retaining device at a temperature below the fibre stability temperature (in other words a temperature below the temperature at which the fibres maintain their properties) and above the melting temperature of the thermoplastic compound. For example, the stability temperature of type E glass fibres and of polypropylene as thermoplastic compound is 600° C. and its melting temperature is 200° C.

According to a second variant, the matrix is obtained by injection of a thermosetting resin between fibres placed in the retaining device and heating of the assembly thus obtained until polymerisation of the resin.

According to another variant, the step to form a matrix comprises a step to densify the walls of the structure by gas CVD or CVI. The gas used may be methane or hydrogen to obtain a carbon matrix, or methyltrichlorosilane and hydrogen to obtain a silicon carbide matrix.

Unlike known conventional techniques, the manufacturing method according to the invention can be used to make cellular structures (for example honeycomb structures) with the following characteristics:

all walls have the same thickness and the fibre content in the walls is constant;

very thin walls with a thickness up to a few hundred μm can be obtained;

a very high geometric precision is obtained; the dimensions of the section of a cell (for example the dimensions of the hexagon in the case of a NIDA structure) are precise to within +or − 5/100 millimetres and cell walls are perpendicular to their base (relative to the hexagonal base in the case of a NIDA structure) within + or −0.5 degrees;

the structures may be made using fibres that are difficult to weave or that cannot be weaved due to their extreme stiffness or their very high fragility (for example, Tyranno SA3 ceramic fibres with a high modulus or low strength fibres).

Another advantage of the method according to the invention is that the matrix of the cellular structure (for example a honeycomb structure) may possibly be deposited by gaseous method. In particular, the lack of a pyrolyzed deposit on fibres makes it possible to make cellular structures (for example NIDA) with a ceramic matrix (SiC) with a carbon interface. Thus, higher performance materials can be obtained than is possible with methods according to known art.

Cellular structures (for example NIDA structures) obtained from the manufacturing method according to the invention have characteristics (strength, etc.) making it possible to use them for nuclear fuel cladding for 4^{th} generation power stations. These structures must be capable of operating at high temperatures (of the order of 1000° C.), they must have good mechanical and thermal properties and they must confine gaseous reaction products (pressure up to 100 bars in the cells). Therefore, the cellular structure (for example a honeycomb structure) obtained using the manufacturing method according to the invention can be used as fuel cladding.

### BRIEF DESCRIPTION OF THE DRAWINGS

The invention will be better understood and other advantages and specific features will appear after reading the following description given as a non-limitative example accompanied by the appended drawings among which:

FIGS. 1a and 1b show a top view and a partial longitudinal perspective view respectively of a retaining device used to make a NIDA structure according to the invention;

FIG. 2 shows a grating used to compact the fibres in the hexagonal grooves of the retaining device shown in FIGS. 1a and 1b;

FIGS. 3a, 3b and 3c show successive steps for the placement of fibres in the grooves of the retaining device shown in FIGS. 1a and 1b.

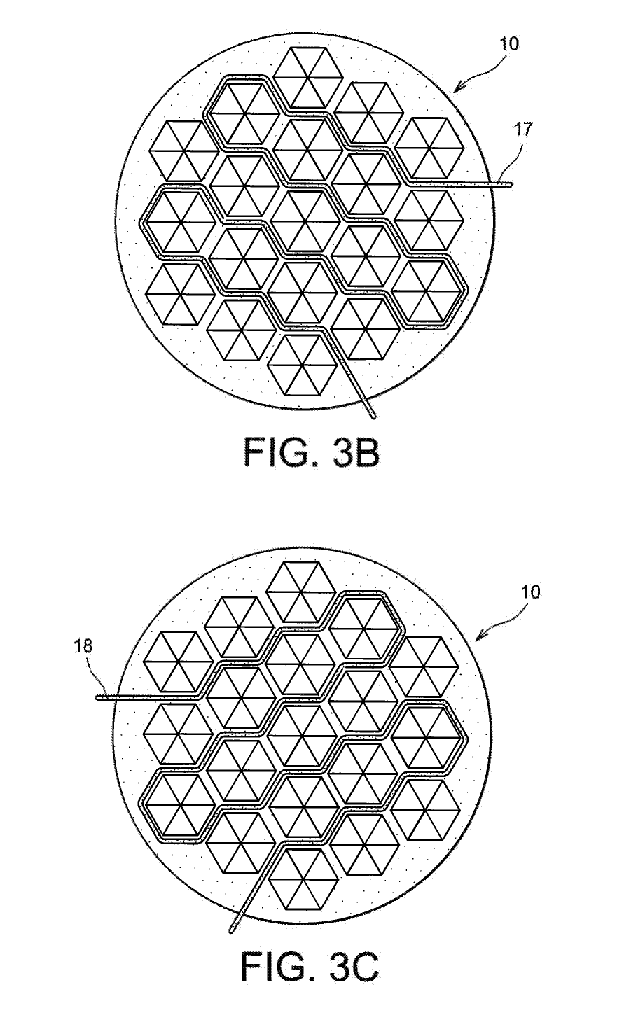

Note that for simplification reasons, the fibre that had already been placed during the step shown in FIG. 3a is not shown in FIG. 3b. Similarly, the fibre shown in FIG. 3a and the fibre shown in FIG. 3b are not shown in 3c. However, it is clear that these fibres are present in the grooves.

### DETAILED PRESENTATION OF A PARTICULAR EMBODIMENT

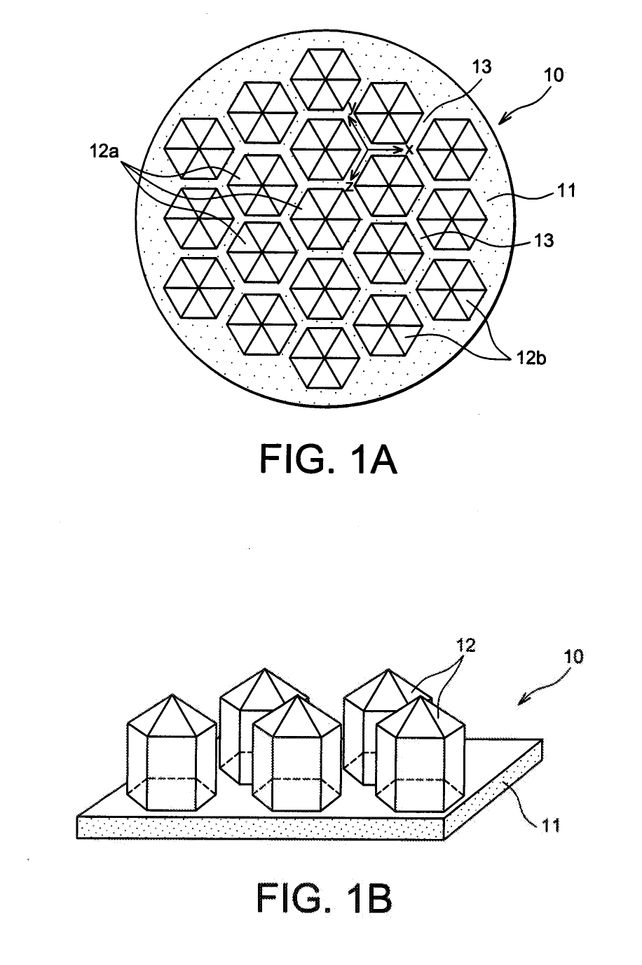

The principle of the invention is based on the placement of continuous fibres in volumes representing the walls of the cells of the cellular structure to be created. A NIDA structure based on hexagonal cells is made using a retaining device comprising hexagonal rods at a spacing from each other so as to obtain grooves forming a hexagonal pattern in which the fibres will be placed (see FIG. 1a).

For example, the retaining device may be composed of a carbon board or carbon foam in which grooves have been machined in a hexagonal pattern. The result is thus a retaining device 10 composed of a base board 11 and of rods with hexagonal bases 12a, 12b arranged uniformly on the base board in a hexagonal pattern (see FIG. 1b).

The retaining device may also be composed solely of rods with hexagonal bases arranged uniformly in a hexagonal pattern, without the base board or with a removable base board. The rods would then have to remain fixed such that the grooves 13 are uniform.

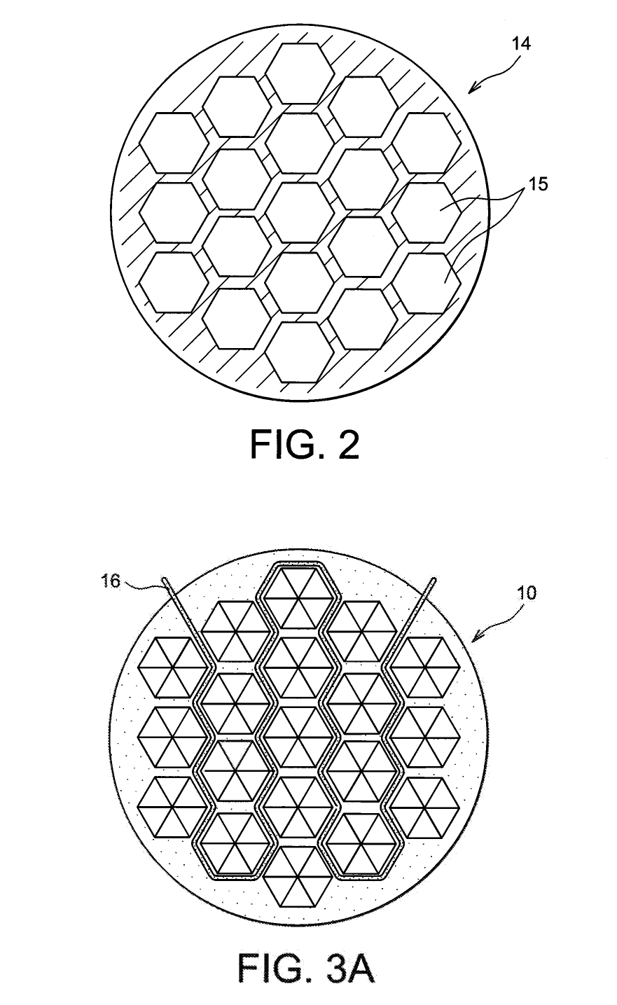

The width and length of the grooves 13 correspond to the thickness and length of the walls of the cells to be obtained and the height of the grooves is greater than the height of the future walls so that a compaction tool 14 (like that shown for example in FIG. 2) can be inserted into the grooves and the position of the continuous fibres in the grooves can be adjusted, this compaction tool forming the impression of the rods of the retaining device.

In addition to a number of rods equal to the number of cells to be obtained (central rods 12a), the retaining device comprises a series of rods around the periphery of the central rods and surrounding them (peripheral rods 12b), the distance between any one rod and its closest adjacent rod forming a groove. In FIG. 1a, the retaining device 10 comprises seven central rods 12a and twelve peripheral rods 12b.

The cells obtained at the peripheral rods could subsequently be eliminated because they do not contain the same number of fibres as the central cells. In this case, the retaining device 10 shown in FIG. 1a can be used to create a NIDA structure with the seven central cells.

The end of the hexagonal base rods may be machined conically or they may be facetted, to facilitate the positioning of continuous fibres in grooves 13 (see FIG. 1b).

The retaining device 10 could possibly be provided with orifices at the bottom of the grooves to facilitate de-insertion of the NIDA structure once formed, by inserting rods in these orifices and applying a pressure to them. Similarly, the retaining device may be coated with a stripping agent to facilitate de-insertion of the NIDA structure and make it possible to reuse the retaining device.

The rods may be coated with fabric or braids composed of fibres, when it is required to increase the fibre content in the vertical direction. This is only possible if the total width of the groove is of the order of 1 mm or more, because the thickness of a fabric or braid is at least 0.3 mm and there are two thicknesses (two rod faces) in a groove.

In order to make it easier to manipulate them and place them in the grooves, the fibres may firstly be dipped in a solution, for example a solution of polyvinyl alcohol in water. The solution used for manipulation of fibres can be eliminated later by heat treatment once the NIDA structure has been made.

Note that instead of using a single continuous fibre, it would be possible to use a bundle of continuous fibres composed of several continuous fibres, such that the diameter of the bundle of fibres is similar to the thickness of the wall to be obtained, for faster placement and better filling of the grooves in the retaining device.

The fibres are placed in the grooves either manually or automatically depending on their length.

Continuous fibres are preferably placed by alternating the directions, so that the same fibre content can be obtained in each wall for one placement series (or layer of fibres).

FIGS. 3a to 3c show one way of placing fibres in the grooves of the retaining device. The starting point is to place a continuous fibre 16 in a groove called groove x and in all grooves with an average orientation of 90° relative to groove x (see FIG. 3a). The next step is to place a continuous fibre 17 in the grooves with an average orientation of −30° relative to groove x (see FIG. 3b). Finally, a continuous fibre 18 is placed in the grooves with an average orientation of +30° relative to groove x (see FIG. 3c). The average orientation of an angle θ° means an orientation of θ equal to + or −30°. Thus, for an average orientation of 90°, the grooves to be filled are all grooves at an angle of +120° or +60° relative to groove x.

Once these steps are complete, it can be seen that each groove at the central rods comprises two fibres. The steps shown in these FIGS. 3a to 3c are repeated until the required wall height is obtained.

In proceeding in this way, the structure is provided with cells with a constant wall thickness. The walls of the cells also include the same number of fibres and therefore have the same density, and the cells are fixed to each other since the fibres are continuous from one wall to the other. This improves the strength of the structure.

Fibres may possibly be compacted after having been placed in the grooves. Compaction of fibres provides a means of adjusting the fibres in the grooves and thus obtaining a uniform fibre height. Compaction may be done using a compaction tool 14 with hexagonal grating 15 (forming the impression of the retaining device rods (see FIG. 2)) that fit into the grooves of the retaining device.

Once the walls have been made, they can be consolidated by inserting vertical fibres by seaming or transferring additional fibres (for example fibres can be placed perpendicular to the wall fibres).

Once the required wall height is obtained, an outer strapping of the NIDA structure can be realised by surrounding the peripheral rods of the retaining device with fibres or threads in order to maintain the cohesion of the NIDA structure. The strapping could then be eliminated by cutting or it could be transformed into a material forming part of the NIDA structure by pyrolysis. For example, strapping can be created using carbon fibres coated with phenolic resin and then polymerising them. The outer strapping consolidates the NIDA structure during the manufacturing process.

Finally, once the NIDA structure has been made, the retaining device is removed. It may be withdrawn by pressing on its rods. It would also be possible to cut the base board of the retaining device at the bottom of the rods to remove the retaining device without deforming the NIDA structure, as we will see below.

All that is necessary to obtain a NIDA structure with an organic matrix is to follow the steps described above, either using fibres that are impregnated by a resin before they are placed in the grooves in the retaining device, or by placing the retaining device comprising the NIDA structure obtained in a mould and injecting a resin or polymer by RTM (Resin Transfer Moulding technique). The NIDA structure comprising the resin is then polymerised, for example by heating.

The blank NIDA structure obtained using the above steps will have to be densified if it is required to obtain a NIDA structure with a carbon or ceramic matrix. This can be done by making a carbon deposit and/or a deposit of ceramic compounds.

In order to perform this densification, the retaining device comprising the NIDA structure is placed in an oven and a chemical infiltration of the NIDA structure is made, for example using carbon or ceramic compounds (silicon carbide or other carbides), usually at temperatures of the order of 1000° C. and with appropriate gas precursors until the required densification is obtained.

At the end of one or several deposition or densification steps, the peripheral rods and the base board of the retaining device (if there is one) may be eliminated by cutting. The central rods may be eliminated by oxidation (which is possible for example following densification by SiC and using a carbon retaining device) or by de-insertion by applying pressure on these rods.

If strapping had been added, the strapping can also be removed by cutting.

Furthermore, NIDA structures may possibly be closed on one or two faces by a fabric that may be of the same nature as the fibres. The result is then a panel.

The fabric(s) is (are) stretched over the surface(s) of the NIDA structure and is (are) bonded to its walls by seams. Seams are made using a thread that may be composed of the same fibres that pass through the fabric(s) and the walls of the NIDA structure.

If the structure is designed to hold a woven element on its upper face and on its lower face, it may be advantageous to use a retaining device without a base board, but only with spaced rods, by means of bands or threads arranged between the rods, at a spacing equal to the thickness of each wall of the NIDA structure to be obtained.

If the NIDA structure is entirely closed by application of a woven element on its lower and upper faces, it is desirable that the material from which the rods of the retaining device are made should be chosen so as to not deteriorate the characteristics of the NIDA structure (for example its lightweight) or so that it can be eliminated during a subsequent step. Thus, the retaining device may for example be made of carbon foam if the final NIDA structure is to be a carbon/carbon NIDA structure and it is required to obtain a NIDA structure with thermal insulation and lightweight functions. If the final NIDA structure is a SiC/SiC composite and if it is required to obtain empty cells, then a retaining device made of carbon foam (with closed pores) could also be used. The retaining device could then be eliminated by oxidation in air at a temperature exceeding 500° C., after partially or totally densifying the NIDA structure by SiC.

We will now describe the formation of a SiC/SiC composite NIDA structure according to the invention.

The NIDA structure that we will describe comprises 19 hexagonal cells with 8 mm long sides, 1 mm thick walls and a height of 10 mm.

In order to obtain a NIDA structure with 19 cells, we choose to use a device made of carbon and composed of a base board with 37 rods with a 35 mm high hexagonal base arranged in a hexagonal pattern and machined conically over 15 mm at their ends. The retaining device used is the same as that shown in FIGS. 1a and 1b. The rods are spaced at intervals from each other so as to obtain a groove thickness of 1 mm (with a precision of +/−20 μm). The grooves are arranged at 90°+/−0.1° from the bottom of the rods.

The fibres used to make the NIDA structure may for example be SiC fibres supplied by Hi-Nicalon. These fibres are in the form of roving containing 500 filaments, the unit diameter of the filaments being 14 μm and the mass per unit length (Tex) of the roving is 205 g/km.

Fibres are dipped into an aqueous solution of 5% polyvinyl alcohol and are cut for example into lengths of 70 cm, and are then placed manually in the grooves of the retaining device. For example, the principle for placing fibres shown in FIGS. 3a to 3c could be used. Note that the length of the fibres in this description is chosen so that all grooves of the device can be filled with a single fibre at least once considering the dimensions of the retaining device, but other lengths are also possible.

Once the fibres have been placed in the grooves, they are adjusted in the grooves by fitting a compaction tool with a hexagonal grating into the grooves of the retaining device. This tool is an impression of the rods of the retaining device; there is therefore one opening (grating) in the compaction tool for each rod in the retaining device.

Another placement and compaction series is then made. These placement and compaction series are repeated until the height required for the walls of the cells is achieved. In our example, the required height is achieved after a total number of 30 series.

The next step is to surround the external hexagonal columns with carbon fibres (for example T 300 fibres) coated with phenolic resin, and the assembly is polymerised at 250° C. Furthermore, the polyvinyl alcohol used to size the fibres is eliminated at this temperature.

The rods of the retaining device are then cut at their intersection with the bottom board. The upper part of the rods is also cut at the same level as the upper part of the walls of the NIDA structure. An adjustment may possibly be obtained by polishing the upper and lower faces of the NIDA structure.

A panel comprising a SiC/SiC composite NIDA structure is obtained by stretching a 1 mm thick SiC fabric (for example an interlock structure fabric) on one of the large faces of the NIDA structure so as to cover the cells, and this fabric is fixed, for example by sewing it with a roving composed of 500 filaments (for example Hi-Nicalon roving) at the contact points of the fabric with the walls of the NIDA structure. In this example, the diameter of the needle used to assemble the fabric to the structure is 400 μm and the space between two seams is 2 mm, in other words there is a seam at 1, 3, 5 and 7 mm on each of the 6 sides of the hexagons of the cells.

The assembly is placed in a pyrolysis oven in order to transform the phenolic resin into carbon. The phenolic resin could pollute the oven and the NIDA structures during subsequent CVI densification steps. Pyrolysis conditions consist of a temperature increase of 10° C. per hour under a vacuum up to 800° C., followed by an increase of 100° C. per hour between 800° C. and 1200° C., a plateau of one hour at 1200° C., and then a temperature drop of 100° C. per hour.

The assembly thus obtained is then placed in a CVI densification oven so as to deposit an approximately 0.2 μm thick carbon coat on the walls of the NIDA structure. The deposition conditions are T=1000° C., P=5 kPa, with propane as precursor, the propane introduction duration being 5 minutes and 30 seconds and the residence time being 3 s. The next step is to deposit an SiC coat. The deposition conditions are T=950° C. and P=2 kPa, with methyltrichlorosilane at 25% in hydrogen as precursor, the precursor infiltration duration being 60 h and the residence time being 1 s.

The retaining hoop (composed of carbon fibres bonded together by a carbon matrix derived from the pyrolysis of phenolic resin present on the fibres), and the peripheral rods of the retaining device are eliminated by cutting.

The remaining assembly is put into an oven (T=550° C. with air scavenging for 30 h) so as to eliminate the remaining carbon rods (central rods).

The content of fibres per unit volume in the walls, calculated from the number of fibres placed in the grooves and the fibre density, is 44% along the x, y and z directions and 4% along a direction perpendicular to the x, y or z directions (the x, y and z directions are shown in FIG. 1a).

The density of the NIDA walls obtained is 2.55 and the porosity is 13%.

The precision on the side dimensions of the cell hexagons is +/− 5/100 mm.

### BIBLIOGRAPHY

[1] <<HexWeb Honeycomb Attributes and Properties: A comprehensive guide to standard Hexcel honeycomb materials, configurations, and mechanical properties>>, page 3 in the technical document issued by the Hexcel Composites company, available on the www.hexcel.com internet site (38 pages).
[2] EP 0 796 829 B1 du 17 Mar. 1997, <<Procédé fabrication d'un panneau du type nid d'abeille en composite carbone/carbone ou carbone/céramique et structures constituées à partir d'un tel panneau>> (Method for Manufacturing a carbon/carbon or carbon/ceramic composite honeycomb type panel and structures composed of such a panel), Rousseau G., EADS.
[3] U.S. Pat. No. 4,824,711 du 25 Apr. 1989, <<Ceramic honeycomb structures and method thereof>>, Cagliostro D. E., NASA.
[4] U.S. Pat. No. 6,830,718 B2 du 14 Dec. 2004, <<Method of manufacturing honeycomb structures>>, Maumus J. P., Snecma Moteurs.

1. Method for manufacturing a cellular structure comprising cells separated by walls, the method including the following steps:
manufacturing of a retaining device comprising rods reproducing the shape of the cells, the rods being separated by grooves reproducing the shape of the walls,
placement of continuous fibres in the grooves to form the walls, each fibre being placed in several successive adjacent grooves,
formation of a matrix around fibres so as to bind the fibres to each other.

2. Method for manufacturing a structure according to claim 1, further comprising an additional step, after the step in which a matrix is formed, to eliminate the retaining device.

3. Method for manufacturing a structure according to claim 1, further comprising a step, after the step to place continuous fibres in the grooves of the retaining device and before the step to form a matrix around the fibres, in which fibres are compacted in the grooves of the retaining device.

4. Method for manufacturing a structure according to claim 1, in which placement is done with at least one single continuous fibre that travels n times from side to side of the retaining device, where n≧1.

5. Method for manufacturing a structure according to claim 4, in which placement is done with at least one single continuous fibre that passes through all the grooves of the retaining device.

6. Method for manufacturing a structure according to claim 1, in which the fibre placement step comprises the following steps:
take a given groove called groove x, placement of a continuous fibre in the grooves with average orientation 90° relative to groove x,
placement of a continuous fibre in the grooves with average orientation −30° relative to groove x,
placement of a continuous fibre in the grooves with average orientation +30° relative to groove x,
an average orientation of θ° corresponding to an orientation of θ equal to + or −30°.

7. Method for manufacturing a structure according to claim 1, in which each groove in the retaining device comprises a single fibre in its thickness.

8. Method for manufacturing a structure according to claim 1, in which several fibres are placed in the grooves at the same time.

9. Method for manufacturing a structure according to claim 1, in which the cells are cylinders with a hexagonal base.

10. Method for manufacturing a structure according to claim 1, in which the rods of the retaining device are arranged in a hexagonal pattern.

11. Method for manufacturing a structure according to claim 1, in which the rods of the retaining device are supported on a support, this support being plane, conical or cylindrical in shape.

12. Method for manufacturing a structure according to claim 1, in which the rods of the retaining device are coated with fabric or braids composed of fibres.

13. Method for manufacturing a structure according to claim 1, further comprising the following steps, after the step in which the matrix is formed around the fibres:
placement of a fibrous reinforcement on one or two faces of the structure so as to cover the ends of the structure cells,
fixing the fibrous reinforcement on said face(s).

14. Method for manufacturing a structure according to claim 2, further comprising the following steps, after the step in which the matrix is formed around the fibres:
placement of the fibrous reinforcement on one or two faces of the structure so as to cover the ends of the structure cells, said placement being done after the step in which the retaining device is eliminated;
fixing the fibrous reinforcement on said face(s).

15. Method for manufacturing a structure according to claim 14, in which placement of the fibrous reinforcement is done before the step in which the retaining device is eliminated.

16. Method for manufacturing a structure according to claim 1, in which the matrix is obtained by injection of a thermoplastic compound between fibres placed in the retaining device at a temperature below the fibre stability temperature and above the melting temperature of the thermoplastic compound.

17. Method for manufacturing a structure according to claim 1, in which the matrix is obtained by injection of a thermosetting resin between fibres placed in the retaining device and heating of the assembly thus obtained until polymerisation of the resin.

18. Method for manufacturing a structure according to claim 1, in which the step to form a matrix comprises a step to densify the walls of the structure by gas CVD or CVI.

19. Method for manufacturing a structure according to claim 1, in which the cell structure is a honeycomb structure.

20. Method for manufacturing a structure according to claim 1, in which the cell structure is a structure in which the sections of the cells have a triangular or parallelepiped shape.

21. Method for manufacturing a cellular structure comprising cells separated by walls, the method including the following steps:
manufacturing of a retaining device comprising rods reproducing the shape of the cells, the rods being separated by grooves reproducing the shape of the walls,
placement of continuous fibres in the grooves to form the walls, each fibre being placed in several successive adjacent grooves,
formation of a matrix around fibres so as to bind the fibres to each other,
using the matrix as fuel cladding.

22. Method for manufacturing a cellular structure comprising cells separated by walls, the method including the following steps:
manufacturing of a retaining device comprising rods reproducing the shape of the cells, the rods being separated by grooves reproducing the shape of the walls,
placement of continuous fibres in the grooves to form the walls, each fibre being placed in several successive adjacent grooves,
formation of a matrix around fibres so as to bind the fibres to each other,
using the matrix as sound absorber.
